(19) United States
(12) Patent Application Publication
(10) Pub. No.: US 2013/0225750 A1
(43) Pub. Date: Aug. 29, 2013

(54) HIGH VISCOSITY BLENDS OF AN IONOMER AND POLY(VINYL ALCOHOL)

(71) Applicants: Elliott Echt, Wilmington, DE (US); Richard Allen Hayes, Beaumont, TX (US)

(72) Inventors: Elliott Echt, Wilmington, DE (US); Richard Allen Hayes, Beaumont, TX (US)

(73) Assignee: E. I. DU PONT DE NEMOURS AND COMPANY, Wilmington, DE (US)

(21) Appl. No.: 13/407,896

(22) Filed: Feb. 29, 2012

(51) Int. Cl. C08L 29/04

(52) U.S. Cl. 524/503

(57) ABSTRACT

Disclosed is a blend composition comprising a combination of (a) about 99 to about 1 weight %, based on the combination of (a) and (b), of a poly(vinyl alcohol) characterized by a hydrolysis level of from about 85 to about 93 mol % and a 4 weight % aqueous viscosity of 16 to about 75 centipoise; and (b) about 1 to about 99 weight % of an ionomer comprising a parent acid copolymer that comprises ethylene and about 18 to about 30 weight % of acrylic acid or methacrylic acid, the acid copolymer having a melt flow rate from about 200 to about 1000 g/10 min., wherein about 50% to about 70% of the carboxylic acid groups of the copolymer are neutralized to carboxylic acid salts comprising potassium and/or sodium cations. Also disclosed are aqueous dispersions, methods to prepare the aqueous dispersions and articles comprising the blend composition.

### FIELD OF THE INVENTION

The present invention is directed to compositions, high viscosity aqueous dispersions and articles comprising ionomer-poly(vinyl alcohol) blends, and methods to prepare them.

### BACKGROUND OF THE INVENTION

Ionomers of ethylene copolymers with alpha,beta-ethylenically unsaturated carboxylic acids are known in the art, wherein at least a portion of the carboxylic acid groups of the copolymer are neutralized to form carboxylate salts comprising alkali metal, alkaline earth metal or transition metal cations. See for example U.S. Pat. Nos. 3,264,272; 3,338,739; 3,355,319; 5,155,157; 5,244,969; 5,304,608; 5,542,677; 5,591,803; 5,688,869; 6,100,336; 6,245,858; 6,518,365; and U.S. Patent Application Publication 2009/0297747.

Aqueous dispersions of ionomers are also known in the art. See for example U.S. Pat. Nos. 3,896,065; 3,904,569; 4,136,069; 4,508,804; 5,409,765; and Japanese Patent Applications JP01009338 and JP05075769. They have been produced by dissolving the acid copolymer precursors in a solvent, neutralization of the acid functionalities with generally ammonia, amines or alkali metal ions, and dilution of the solution into water followed by partial or complete removal of the solvent. See for example U.S. Pat. Nos. 2,313,144; 3,296,172; 3,389,109; 3,562,196; 5,430,111; 5,591,806; British Patent GB1243303; Japanese Patent Applications JP50084687 and JP2009091426.

Aqueous ionomer dispersions have also been produced by heating acid copolymer precursors or ionomers in hot aqueous ammonia and other neutralizing agents. See for example U.S. Pat. Nos. 3,644,258; 3,674,896; 3,823,108; 3,872,039; 3,899,389; 3,970,626; 3,983,268; 4,400,440; 4,540,736; 5,160,484; 5,206,279; 5,330,788; 5,387,635; 5,550,177; 6,852,792; U.S. Patent Application Publication 2007/0117916; Japanese Patent Application JP06000872; and PCT Patent Application Publication WO2000/044801.

Aqueous ionomer dispersions have also been produced by dispersing the acid copolymer precursor in aqueous solutions of neutralizing agents at temperatures under high shear process conditions above the boiling point of water, necessitating the use of pressure vessels such as autoclaves and extruders. See for example U.S. Pat. Nos. 4,775,713; 4,970,258; 4,978,707; 5,082,697; 5,374,687; 5,445,893; 5,993,604; 6,482,886; 7,279,513; 7,528,080; 7,588,662; U.S. Patent Application Publications 2005/0100754; 2005/0271888; 2006/0124554; 2007/0137808; 2007/0137809; 2007/0137810; 2007/0137811; 2007/0137813; 2007/0141323; 2007/0144697; 2007/0243331; 2007/0284069; 2007/0292705; 2007/0295464; 2007/0295465; 2008/0000598; 2008/0000602; 2008/0041543; 2008/0073045; 2008/0073046; 2008/0118728; 2008/0135195; 2008/0176968; 2008/0182040; 2008/0216977; 2008/0230195; 2008/0292833; 2008/0295985; 2009/0194450; 2009/0253321; European Patent Application EP1163276; PCT Patent Application WO 2011/058119; WO 2011/058121; WO 2011/068525; and Japanese Patent Applications JP2958120; JP10006640; and JP50135141.

Aqueous ionomer dispersions have also been produced by dispersing the ionomer in aqueous solutions under high shear process conditions at temperatures above the boiling point of water, necessitating the use of pressure vessels such as autoclaves and extruders. See for example U.S. Pat. Nos. 4,173,669; 4,329,305; 4,410,655; 440,908; 6,458,897; Japanese Applications JP11158332; JP2000328046; JP2005075878; and PCT Patent Application Publication WO1999/10276.

Aqueous ionomer dispersions have also been produced by dispersing highly neutralized, low melt index (MI) ionomers in hot water. See for example U.S. Pat. Nos. 3,321,819; 3,472,825; and 4,181,566.

Blends of aqueous ionomer dispersions with poly(vinyl alcohol) solutions are known in the art. See for example U.S. Pat. Nos. 3,674,896; 3,896,065; 4,547,456; 4,575,532; 4,600,746; 5,192,620; 5,358,790; and 6,821,373; European Patent Application EP 868363; Japanese Applications JPH09124975; JP2003049035; and JP60072973. The blends described suffer the shortcoming of a complicated ionomer dispersion process, as discussed above.

### SUMMARY OF THE INVENTION

The invention relates to a blend composition comprising or consisting essentially of

(a) about 99 to about 1 weight %, based on the combination of (a) and (b), of a poly(vinyl alcohol) composition comprising or consisting essentially of a poly(vinyl alcohol) with a hydrolysis level of from about 85 to about 93 mol % and a 4 weight % aqueous viscosity at 20° C. of from 16 to about 75 centipoise (cp); and

(b) about 1 to about 99 weight % of an ionomer composition comprising or consisting essentially of a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof.

The invention also provides an article comprising or consisting essentially of the blend composition above.

The invention also relates to an aqueous ionomer-poly(vinyl alcohol) dispersion comprising or consisting essentially of water and about 0.001 to about 50 weight % of the combination of (a) and (b) described above.

Surprisingly, the viscosity of the dispersion is at least 25% higher than a similar aqueous dispersion of the poly(vinyl alcohol) without ionomer.

The invention also provides a method for making an aqueous ionomer-poly(vinyl alcohol) dispersion comprising a mixture of an ionomer composition and a poly(vinyl alcohol) composition, the method comprising or consisting essentially of

(1) providing an aqueous poly(vinyl alcohol) solution comprising or consisting essentially of water and the poly(vinyl alcohol) composition described in (a) above;

(2) providing an ionomer composition comprising or consisting essentially of the ionomer composition described in (b) above; and

(3) mixing the ionomer composition with the aqueous poly(vinyl alcohol) composition solution optionally with heating; and

(4) optionally cooling the heated aqueous blend dispersion to a temperature of about 20 to 30° C., wherein the combination remains dispersed in the liquid phase;

wherein the aqueous ionomer-poly(vinyl alcohol) dispersion is as described above.

### DETAILED DESCRIPTION OF THE INVENTION

Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight.

When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized comonomers.

As used herein, “disperse,” “dispersing” and related terms refer to a process in which solid articles such as pellets of polymer are mixed with water and over a brief period of time disappear into the liquid phase. The terms “aqueous dispersion” and “dispersion” describe a free-flowing liquid with no solids visible to the human eye. No characterization is made regarding the interaction of the polymer molecules with the water molecules in such aqueous dispersions. “Self-dispersible” means that the material disperses readily in hot (80 to 100° C.) water without need for additional dispersants or reagents.

As used herein, the terms “poly(vinyl alcohol)” and “PVOH” refer generally to poly(vinyl alcohol) homopolymers or copolymers unless specified with more particularity.

Viscosity is a measure of the resistance of a fluid to being deformed by either shear or tensile stress. In everyday terms for fluids only, viscosity may be thought of as “thickness” or “internal friction”. For example, water is “thin”, having a lower viscosity, while honey is “thick”, having a higher viscosity. The less viscous a fluid is, the greater its ease of movement (fluidity). As used herein, viscosity refers to dynamic or absolute viscosity.

Methods to produce high viscosity aqueous dispersions comprising certain ionomer-poly(vinyl alcohol) combinations are disclosed herein. In contrast, previous methods required significantly more rigorous conditions to form dispersions. The dispersion methods provide process simplifications that require less energy and are inherently safer than disclosed in the prior art dispersion methods, such as high pressure, high shear, autoclave processes or extrusion processes.

Surprisingly, we have found that ionomer-poly(vinyl alcohol) combinations with certain compositional characteristics readily form high viscosity aqueous dispersions when mixed with hot water under low shear conditions.

Poly(Vinyl Alcohol) Composition

The blends and aqueous dispersions contain poly(vinyl alcohol) compositions comprising or consisting essentially of a poly(vinyl alcohol) with a hydrolysis level of from about 85 to about 93 mol % and a 4 weight % aqueous viscosity of from 16 to about 75 centipoise (cp).

Poly(vinyl alcohol) compositions can be obtained by known and conventional methods. Poly(vinyl alcohol) compositions are typically obtained through polymerization of vinyl acetate monomer, followed by conversion of the as-made poly(vinyl acetate) composition to the poly(vinyl alcohol) composition through alcoholysis or hydrolysis processes. Strictly, alcoholysis is carried out with a basic catalyst in alcohol as reaction medium and leads to the corresponding alkyl acetate and the poly(vinyl alcohol) unit. Hydrolysis, in water, generally uses larger amounts of metallic caustic base, leading to the poly(vinyl alcohol) unit and the corresponding metal acetate rather than alkyl acetate. Formation of metal salts, i.e. acetates, has led to use of the term “saponification” for the process, akin to formation of metal salts of fatty acids with caustic, in making soaps. When aqueous alcohol is used as the reaction medium both hydrolysis and alcoholysis may occur. However, U.S. Pat. No. 2,940,948 discloses that under specific circumstances, even with aqueous alcohol, alcoholysis rather than hydrolysis occurs. While the distinction strictly depends on reaction products, the terms have tended to be used non-rigorously.

It is common to use the term “partially hydrolyzed” or “partially saponified” when not all the acetate groups are completely converted to alcohol groups. When poly(vinyl acetate) homopolymer is only partially hydrolyzed, the resulting poly(vinyl alcohol) is actually a vinyl alcohol/vinyl acetate copolymer. However, as noted, such polymers are generally referred to as poly(vinyl alcohol) homopolymers. Surprisingly, we have found that some partially hydrolyzed poly(vinyl alcohol) compositions when combined with the ionomers described above provide high viscosity aqueous dispersions. The degree of hydrolysis of the poly(vinyl alcohol) composition useful in preparing high viscosity aqueous dispersions may be from about 85 to about 93 mol %, preferably from about 86 to about 90 mol %.

The viscosity of poly(vinyl alcohol) as a 4 weight % aqueous solution at 20° C. serves as an industrial standard relating to the degree of polymerization and average molecular weight of the poly(vinyl alcohol) composition.

The 4 weight % aqueous viscosity at 20° C. of the poly(vinyl alcohol) composition useful for preparing high viscosity aqueous dispersions with ionomers may be from 16 to about 75 centipoise (cp), preferably from about 20 to about 75 cp, more preferably from about 20 to about 60 cp. Of note are PVOH compositions with 4 weight % aqueous viscosity at 20° C. of 20 to 30 cp, 20 to 50 cp, 25 to 40 cp, or 40 to 55 cp.

Specific partially hydrolyzed poly(vinyl alcohol)s useful herein have hydrolysis level of 87 to 89% and 4 weight % aqueous viscosity at 20° C. of 23 to 27 cp or 44 to 50 cp.

Aqueous solutions comprising about 5 to 20 weight % of such poly(vinyl alcohol) compositions may have viscosity at 20° C. of about 10 to about 10,000 cp.

The combination of the 4 weight % aqueous viscosity at 20° C. and the hydrolysis level of the poly(vinyl alcohol) composition provides the desirable high viscosity attributes when blended with the ionomer composition, as described herein.

Optionally, poly(vinyl alcohol) copolymers are also useful for forming high viscosity aqueous dispersions. The term “copolymer” in this regard is used herein for materials which result from hydrolysis of a vinyl acetate copolymer also containing units derived from a monomer other than vinyl acetate, such an alkyl acrylate, including for example methyl acrylate or methyl methacrylate.

The poly(vinyl alcohol) composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and/or coupling agents.

Ionomer Composition

The ionomer used herein is derived from certain parent acid copolymers comprising copolymerized units of ethylene and about 18 to about 30 weight % of copolymerized units of an alpha, beta-ethylenically unsaturated carboxylic acid such as acrylic acid or methacrylic acid. Preferably, the parent acid copolymer used herein comprises about 19 to about 25 weight %, or more preferably about 19 to about 23 weight %, of the alpha, beta-ethylenically unsaturated carboxylic acid, based on the total weight of the copolymer.

Preferably, the alpha, beta-ethylenically unsaturated carboxylic acid is methacrylic acid. Of note are acid copolymers consisting essentially of copolymerized units of ethylene and copolymerized units of the alpha, beta-ethylenically unsaturated carboxylic acid and 0 weight % of additional comonomers; that is, dipolymers of ethylene and the alpha, beta-ethylenically unsaturated carboxylic acid. Preferred acid copolymers are ethylene methacrylic acid dipolymers.

The parent acid copolymers used herein may be polymerized as disclosed in U.S. Pat. Nos. 3,404,134; 5,028,674; 6,500,888; and 6,518,365.

The parent acid copolymers used herein preferably have a melt flow rate (MFR) of about 200 to about 1000 grams/10 min as measured by ASTM D1238 at 190° C. using a 2160 g load. A similar ISO test is ISO 1133. Alternatively, the parent acid copolymers have MFR from a lower limit of 200, 250 or 300 to an upper limit of 400, 500, 600 or 1000. The preferred melt flow rate of the parent acid copolymer provides ionomers with optimum physical properties in the final shaped article while still allowing for rapid self-dispersion in hot water. Ionomers derived from parent acid copolymers with melt flow rates below about 200 grams/10 minutes have minimal hot water self-dispersibility, while ionomers derived from parent acid copolymer melt flow rates of greater than about 1000 grams/10 minutes may reduce the physical properties in the intended enduse.

In some embodiments, blends of two or more ethylene acid copolymers may be used, provided that the aggregate components and properties of the blend fall within the limits described above for the ethylene acid copolymers. For example, two ethylene methacrylic acid dipolymers may be used such that the total weight % of methacrylic acid is about 18 to about 30 weight % of the total polymeric material and the melt flow rate of the blend is about 200 to about 1000 grams/10 min.

The ionomers disclosed herein are produced from the parent acid copolymers, wherein from about 50 to about 70%, or preferably from about 55 to about 60%, such as about 60%, of the total carboxylic acid groups of the parent acid copolymers, as calculated for the non-neutralized parent acid copolymers, are neutralized to form carboxylic acid salts with potassium ions, sodium ions or combinations thereof. The parent acid copolymers may be neutralized using methods disclosed in, for example, U.S. Pat. No. 3,404,134. Ionomers wherein the cations of the carboxylate salts consist essentially of sodium cations are notable.

Importantly, the ionomer compositions combine the properties of being self-dispersible in hot water along with being thermoplastic, allowing for melt fabrication into many articles of commerce. Preferably, the ionomers used herein have a melt flow rate (MFR) of at least 1 gram/10 min, such as about 1 to about 20 grams/10 min as measured by ASTM D1238 at 190° C. using a 2160 g load. More preferably, the ionomer composition has a MFR of about 1 to about 10 grams/10 min, and most preferably has a MFR of about 1 to about 5 grams/10 min. The combination of the above described parent acid copolymer melt flow rates and the neutralization levels provides ionomers which combine the properties of being easily self-dispersible in hot water and easily melt fabricated into articles of commerce.

In some embodiments, blends of two or more ionomers may be used, provided that the aggregate components and properties of the blend fall within the limits described above for the ionomers.

Aqueous dispersions comprising about 5 to 20 weight % of such ionomers may have viscosity at 23° C. of about 1 to about 30 cp.

The ionomer composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and coupling agents.

Blend Composition

The blend composition comprises or consists essentially of a combination of about 1 to about 99 weight % of a poly(vinyl alcohol) composition and about 99 to about 1 weight % of an ionomer composition, wherein the ionomer and poly(vinyl alcohol) are as described above.

Of note are compositions wherein the ionomer is present in the combination in an amount from a lower limit of about 10, 20, 30, 40 or 50 weight % to an upper limit of about 60, 70, 80, 90, or 95 weight %, the poly(vinyl alcohol) being present in a complementary amount. Also of note are compositions wherein the ionomer is present in the combination in an amount from a lower limit of about 60, 70, or 75 weight % to an upper limit of about 80, 85, 90 or 95 weight %, the poly(vinyl alcohol) being present in a complementary amount.

Preferably, the ionomer and the PVOH may be blended in an aqueous blend dispersion as discussed in greater detail below, which avoids heating the PVOH above its melting point. The aqueous blend dispersion can in turn be processed into a solid by drying (removal of water) to provide an article. For example, the aqueous blend dispersion may be formed into a cast film by forming a thin layer of the aqueous blend, followed by drying.

The blend composition article may take any physical form desired, such as powder, pellets, melt cut pellets, coatings, films, sheets, molded articles and the like.

Aqueous Dispersions

Surprisingly, when an aqueous dispersion of the ionomer and poly(vinyl alcohol) with a hydrolysis level of from about 85 to about 93 mol % and a 4 weight % aqueous viscosity of 16 to about 75 cp is formed, the viscosity of the dispersion may be at least 25% higher than a similar aqueous dispersion of the poly(vinyl alcohol) without ionomer. Even more surprisingly, the viscosity increases as the ratio of ionomer to poly(vinyl alcohol) increases, up to at least a 4:1 ratio of ionomer to poly(vinyl alcohol), even though the ionomer dispersion without PVOH may have a lower viscosity than the PVOH solution without ionomer. Aqueous dispersions with a 4:1 ratio of ionomer to poly(vinyl alcohol) exhibit viscosities from about 4 to about 20 (or higher) times that of a corresponding aqueous dispersion the poly(vinyl alcohol) without ionomer. The viscosity at 25° C. may be from about 700 centipoise to about 24,000 centipoise or higher. For comparison, the viscosity at 25° C. of water is 0.894 centipoise and chocolate syrup may range from about 10,000 to about 25,000 centipoise, depending on its composition and water content.

Aqueous dispersions of ionomer combined with poly(vinyl alcohol) compositions having hydrolysis levels from about 95 to 100 mol % do not exhibit such behavior. Aqueous dispersions of ionomer combined with poly(vinyl alcohol) compositions having hydrolysis levels of about 85 to about 93 mol % and 4 weight % aqueous viscosity of 15 cp or less also do not exhibit such behavior. In those dispersions, the increase of viscosity when the poly(vinyl alcohol) is combined with the ionomer is less than 25% and the viscosity generally decreases as the amount of ionomer increases.

A method for making an aqueous ionomer-poly(vinyl alcohol) dispersion comprising a combination of an ionomer composition and a poly(vinyl alcohol) composition comprises or consists essentially of

(1) providing an aqueous poly(vinyl alcohol) solution comprising or consisting essentially of water and the poly(vinyl alcohol) composition described in (a) above;

(2) providing an ionomer composition comprising or consisting essentially of the ionomer composition described in (b) above; and

(3) mixing the ionomer composition with the aqueous poly(vinyl alcohol) solution optionally with heating; and

(4) optionally cooling the heated aqueous blend dispersion to a temperature of about 20 to 30° C., wherein the ionomer remains dispersed in the liquid phase;

wherein the aqueous ionomer-poly(vinyl alcohol) dispersion is as described above.

The dispersion method described herein surprisingly allows for the production of aqueous dispersions of combinations of poly(vinyl alcohol) and ionomers under very mild process conditions, such as low shear (e.g. simply stirring a mixture of a heated poly(vinyl alcohol) and an ionomer, either as a solid or as an aqueous dispersion) and relatively low temperature (less than the boiling point of water at atmospheric pressure), requiring less energy than prior art dispersion processes. This dispersion method further provides an inherently safer dispersion process through the use of preformed blend compositions by allowing for the avoidance of strong bases, such as aqueous sodium hydroxide (caustic), aqueous potassium hydroxide or ammonia, during the dispersion process.

Strictly speaking, the blend dispersion generally includes a solution of the poly(vinyl alcohol) composition, and a dispersion of the ionomer composition hereinafter referred to as a dispersion for brevity.

The aqueous poly(vinyl alcohol) solution may be prepared by any method disclosed in the art. Generally, such processes include forming a mixture of the PVOH composition in water at a temperature of about 20° C. to about 30° C., followed by heating the mixture at a temperature and for a time until the PVOH composition dissolves to form the aqueous PVOH composition solution. The aqueous dissolution temperature of the PVOH is generally dependent on the hydrolysis level of the specific PVOH composition. For PVOH compositions with hydrolysis levels equal to or less than of about 89 mole %, the aqueous dissolution temperature may be generally in the temperature range from about 20° C. to about 40° C. For PVOH compositions with hydrolysis levels in the range of about 90 mole % to about 93 mole %, the aqueous dissolution temperature may be generally in the temperature range from about 40° C. to about 60° C. In order to prepare the dispersion faster, it may be useful to heat the mixture of water and PVOH at temperatures higher than the threshold temperature for dissolution. For example, the water-PVOH mixture may be heated to about 90 to 95° C., regardless of hydrolysis level.

The poly(vinyl alcohol) solution may be produced in any suitable vessel, such as a tank, vat, pail or the like. Stirring is useful to provide effective contact of the bulk solid poly(vinyl alcohol) composition with water as dissolution proceeds. Preferably the solution is produced in about 1 hour or less, such as in about 30 minutes or in about 20 minutes or less.

Due to the rapid dissolution of the poly(vinyl alcohol) compositions, it is further contemplated that the dissolution process may proceed within a pipeline in which the components of the solution are charged at one end of the pipeline and form the solution as they proceed down the length of the pipeline. For example, the PVOH may be mixed with water and passed through a heated zone, with or without added mixing, such as through static mixers. Alternatively, the PVOH may be mixed with hot water and passed through a pipeline, with or without added mixing, such as through static mixers.

The aqueous poly(vinyl alcohol) solution preferably comprises from a lower limit of about 0.001, about 0.01, about 0.1 or about 1% to an upper limit of about 10, about 20, about 30 or about 50 weight %, of the poly(vinyl alcohol) composition based on the total weight of the blend composition and the water.

In some embodiments, the dispersion method comprises providing a preformed aqueous solution of a poly(vinyl alcohol) composition and mixing it with a preformed aqueous dispersion of an ionomer composition. The aqueous ionomer dispersion may be formed by mixing the solid ionomer composition with water heated to a temperature from about 80 to about 100° C. (under low shear conditions) to provide a heated aqueous ionomer composition dispersion; optionally followed by cooling to a temperature of about 20 to about 30° C., wherein the ionomer remains dispersed in the aqueous phase.

The aqueous dispersion of an ionomer composition can be produced by contacting the solid ionomer composition, for example in the form of melt cut pellet(s), with water at a temperature from about 80 to about 100° C. In some embodiments, the temperature is in the range from about 85 to about 90° C. Surprisingly, the ionomer compositions described herein can be dispersed in water at 80 to 100° C., lower than that expected based on the prior art and requiring significantly less energy. However, one can appreciate that if the ionomer compositions disperse in that temperature range they can also be dispersed at temperatures above 100° C.

The ionomer dispersion may be produced in any suitable vessel, such as a tank, vat, pail or the like. Stirring is useful to provide effective contact of the bulk solid ionomer composition with water as dispersion proceeds. Preferably the dispersion is produced in about 1 hour or less, such as in about 30 minutes or in about 20 minutes or less. Smaller particle size of the solid ionomer may reduce time of dispersion. Due to the surprisingly rapid dispersibility of the ionomer compositions, it is further contemplated that the process may proceed within a pipeline in which the components of the dispersion are charged at one end of the pipeline and form the dispersion as they proceed down the length of the pipeline. For example, the ionomer composition may be mixed with water and passed through a heated zone, with or without added mixing, such as through static mixers. Alternatively, the ionomer composition may be mixed with hot water and passed through a pipeline, with or without added mixing, such as through static mixers.

In one embodiment, the ionomer composition is mixed with water under low shear conditions at room temperature (about 20 to 25° C.) and the temperature is raised to about 80 to about 100° C. In another embodiment, the ionomer composition is mixed with water under low shear conditions at room temperature and the temperature is raised to about 85 to about 90° C.

In another embodiment, the ionomer composition is mixed with water preheated to a temperature of about 80 to about 100° C. under low shear conditions. In another embodiment, the ionomer composition is mixed with water preheated to a temperature of about 85 to about 90° C. under low shear conditions.

The aqueous ionomer composition dispersion preferably comprises from a lower limit of about 0.001 or about 1% to an upper limit of about 10, about 20, about 30 or about 50 weight %, of the ionomer composition based on the total weight of the blend composition and the water.

Once prepared, the aqueous poly(vinyl alcohol) solution and the aqueous ionomer dispersion may be mixed together by any suitable means, with or without additional heating. In some instances, the aqueous poly(vinyl alcohol) solution and the aqueous ionomer dispersion may be maintained at or near the elevated temperatures necessary for their preparation through the mixing step. The resulting aqueous blend may be used in additional operations at the elevated temperatures necessary for its preparation. Alternatively, the resulting aqueous blend may then be cooled to ambient temperatures (about 20 to 30° C.) for storage or subsequent use.

The blend dispersion may also be prepared by mixing the aqueous PVOH solution with the aqueous ionomer dispersion, both at about 20 to 30° C. before and through the mixing step.

The order of mixing the aqueous PVOH solution and the aqueous ionomer dispersion is not critical, provided the PVOH is in the form of an aqueous solution prior to mixing with the ionomer dispersion. For example, the PVOH solution may be prepared in a suitable vessel and the aqueous ionomer dispersion, prepared separately, is subsequently added to the vessel. The mixing can occur in any suitable mixing vessel, such as a tank, vat, pail or the like. Stirring may be useful to provide sufficient rapid mixing of the poly(vinyl alcohol) solution and the ionomer dispersion. The mixing may proceed within a pipeline in which the PVOH solution and the ionomer dispersion components of the blend dispersion are charged at one end of the pipeline and form the blend as they proceed down the length of the pipeline, with or without added mixing, such as through static mixers.

In other embodiments, the ionomer in solid form, such as melt cut pellets, may be mixed with the aqueous poly(vinyl alcohol) solution with heating to prepare the blend dispersion.

In one such embodiment, the method comprises or consists essentially of

(1) heating a mixture of water and a poly(vinyl alcohol) composition described above to provide an aqueous poly(vinyl alcohol) solution;

(2) the ionomer composition comprising or consisting essentially of the ionomer described above is in solid form;

and the mixing of step (3) comprises

(a) heating the aqueous poly(vinyl alcohol) solution to a temperature from about 80 to about 100° C. (under low shear conditions);

(b) contacting a solid ionomer composition with the heated aqueous poly(vinyl alcohol) solution;

(c) continuing heating at a temperature from about 80 to about 100° C. (under low shear conditions) until the solid ionomer composition has completely dispersed; and

(4) optionally cooling to a temperature of about 20 to 30° C.;

wherein the aqueous ionomer-poly(vinyl alcohol) dispersion is as described above.

In another such embodiment, the method comprises or consists essentially of
(1) heating a mixture of water and a poly(vinyl alcohol) composition described above to provide an aqueous poly(vinyl alcohol) solution;
(2) the ionomer composition comprising or consisting essentially of the ionomer described above is in solid form;

and the mixing of step (3) comprises

(d) contacting the solid ionomer composition with the aqueous poly(vinyl alcohol) solution to provide a mixture;

(e) heating the mixture to a temperature from about 80 to about 100° C. (under low shear conditions) until the solid ionomer composition has completely dispersed; and

(4) optionally cooling to a temperature of about 20 to 30° C.;

wherein the aqueous ionomer-poly(vinyl alcohol) dispersion is as described above.

The order of mixing the aqueous PVOH solution and the solid ionomer dispersion is not critical, provided the PVOH is in the form of an aqueous solution prior to mixing with the ionomer. For example, the PVOH solution may be prepared in a suitable vessel and the solid ionomer is subsequently added to the vessel.

The mixing can occur in any suitable mixing vessel, such as a tank, vat, pail or the like. Stirring may be useful to provide sufficient rapid mixing of the poly(vinyl alcohol) solution and the solid ionomer. Smaller particle size of the solid ionomer may reduce time of dispersion. The mixing may proceed within a heated pipeline in which the PVOH solution and the solid ionomer components of the blend dispersion are charged at one end of the pipeline and form the blend as they proceed down the length of the pipeline, with or without added mixing, such as through static mixers.

Additional water may be added after the initial mixing, if desired, to provide dispersions with lower concentrations of PVOH and ionomer. For example a concentrated dispersion may be prepared and stored for a period of time and then diluted with water to provide a dispersion with lower concentration at the time of use.

The dispersion may include other additives known in the art. For example, the composition may include a wax additive, such as a microcrystalline wax or a polyethylene wax, which serves as an anti-blocking agent as well as to improve the coefficient of friction. Other types of additives include fumed silica, which reduces tack of the blend composition at room temperature, fillers, cross-linking agents, anti-static agents, defoamers, dyes, brighteners, processing aids, flow enhancing additives, lubricants, dyes, pigments, flame retardants, impact modifiers, nucleating agents, anti-blocking agents, thermal stabilizers, UV absorbers, UV stabilizers, chelating agents, coupling agents and the like.

Inorganic fillers include calcium carbonate, titanium dioxide, silica, talc, barium sulfate, carbon black, ceramics, chalk or mixtures thereof. Clay fillers natural clays, synthetic clays, treated clays, untreated clays, organoclays, smectite clays, bentonite clays, hectorite days, wollastonite clays, montmorillonite clays, kaolin, or mixtures thereof. Organic fillers include natural starch, modified starch, chemically modified starch, rice starch, corn starch, wood flour, cellulose, and mixtures thereof.

Starch is a natural product composed of various amounts of amylose and amylopectin. As used herein “starch” refers generally to starch, starch derivatives, modified starch, thermoplastic starch, cationic starch, anionic starch, starch esters, such as starch acetate, starch hydroxyethyl ether, alkyl starches, amine starches, phosphate starches and dialdehyde starches. Important plant source of starch used in the paper industry are potato, barley, wheat corn, waxy maize (corn with no amylose in the starch), and tapioca.

Starch can be modified in a number of ways. The viscosity of the starch can be reduced by use of enzymes, thermal treatment, ammonium persulfate, hypochlorite, or acid. In addition, the starch can be chemically modified, for example via hydroxyethylation, carboxymethylation, acetylation, or phosphatizing. Thermoplastic starch may be produced, for example, as disclosed within U.S. Pat. No. 5,362,777, which discloses the mixing and heating of native or modified starch with high boiling plasticizers, such as glycerin or sorbitol, in such a way that the starch has little or no crystallinity, a low glass transition temperature and a low water content.

### EXAMPLES

Table 1 summarizes the ethylene methacrylic acid dipolymers with copolymerized units of methacrylic acid at the indicated weight % of the total acid copolymer used to prepare the ionomers in Table 2. Ionomers were prepared from the acid copolymers using standard conditions. Melt flow rate (MFR) was measured according to ASTM D1238 at 190° C. using a 2160 g load. A similar ISO test is ISO 1133.

TABLE 1

| | Methacrylic acid (weight %) | MFR (g/10 min) |
|---|---|---|
| ACR-1 | 19 | 400 |
| ACR-2 | 15 | 200 |
| ACR-3 | 19 | 180 |
| ACR-4 | 19 | 60 |
| ACR-5 | 21.7 | 30 |
| ACR-6 | 19 | 250 |
| ACR-7 | 23 | 270 |

### Ionomers

Table 2 summarizes the ionomers derived from the ethylene methacrylic acid dipolymers, with the indicated percentage of the carboxylic acid groups neutralized with sodium hydroxide to form sodium salts or potassium carbonate to form potassium salts. The water dispersibility was determined according to the following procedure, which illustrates addition of the non-neutralized acid copolymer or ionomer to heated water. The procedure produced a mixture of water and 10 weight % solid loading (as weighed prior to addition to the water). Into a 1 quart (946.4 ml) metal can placed into a heating mantle element was added 500 ml of distilled water. An overhead paddle stirrer (3-paddle propeller type stirrer) was positioned into the center of the metal can and turned on to provide slow mixing. A thermocouple was positioned below the water surface between the paddle stirrer and the metal can surface. The paddle stirrer was typically set at a speed of about 170 rpm at the beginning of the process and generally raised to about 300 to 470 rpm as the viscosity built during dispersion formation. The distilled water was then heated with an Omega temperature controller to a temperature of 90 C. The non-neutralized acid copolymer resin ACR-1 or ionomer (55.5 grams, in the form of melt cut pellets) indicated in Table 1 was then added in one portion and the resulting mixture was stirred for a total of 20 minutes. The resulting mixture was then allowed to cool to room temperature.

TABLE 2

| | | | | | Water |
|---|---|---|---|---|---|
| | Base | Neutralization | | MFR | Dispersibility |
| Sample | Copolymer | Ion | Level (%) | (g/10 min.) | at 90° C. |
| ACR-1 | ACR-1 | — | 0 | — | No |
| ION-1 | ACR-2 | Na | 51 | 4 | No |
| ION-2 | ACR-2 | Na | 70 | 0.9 | No |
| ION-3 | ACR-1 | Na | 40 | 12.7 | No |
| ION-4 | ACR-3 | Na | 45 | 3.7 | No |
| ION-5 | ACR-4 | Na | 50 | 0.8 | No |
| ION-6 | ACR-5 | Na | 40 | 0.7 | No |
| ION-7 | ACR-1 | Na | 50 | 5.3 | Yes |
| ION-8 | ACR-1 | Na | 60 | 1.4 | Yes |
| ION-9 | ACR-1 | Na | 70 | 1 | Yes |
| ION-10 | ACR-7 | Na | 55 | 1.4 | Yes |
| ION-11 | ACR-2 | K | 65 | 2.3 | No |
| ION-12 | ACR-4 | K | 50 | 0.9 | No |
| ION-13 | ACR-6 | K | 50 | 3.9 | Yes |
| ION-14 | ACR-1 | K | 50 | 5.4 | Yes |

The data in Table 2 show that ionomers prepared from an acid copolymer with 15 weight % of methacrylic acid did not form aqueous dispersions using this procedure, even with high neutralization levels (Ionomers ION-1, ION-2 and ION-11). Ionomers with neutralization levels less than 50% did not form dispersions, even with acid comonomers above 19 weight % of the acid copolymer (lonomers ION-3, ION-4 and ION-6). Ionomers ION-5, ION-7, ION-12 and ION-14 involved acid copolymers with the same weight % of methacrylic acid and neutralized to the same level, but with different melt flows. ION-5 and ION-12, each derived from a parent acid copolymer with MFR of 60 and having MFR less than 1, did not provide dispersions. However, ION-7 and ION-14, each derived from a parent acid copolymer with MFR of 400 and having MFR greater than 1, provided dispersions.

### Examples 1-12 and Comparative Examples C2-C19

These examples show the method of mixing preformed aqueous PVOH solutions with a preformed aqueous ionomer dispersion. An 11.6 weight % aqueous dispersion of ION-8 was prepared by suspending the solid material in hot (90 to 95° C.) water and stirring until all solid material disappeared. The ionomer dispersion was a translucent milky liquid.

Samples of poly(vinyl alcohol) (PVOH) compositions are commercially available from DuPont under the Elvanol® tradename. Aqueous solutions of the PVOH materials in Table 3 were prepared by suspending the solid material in cool water and then heating to 90 to 95° C. with stirring until all solid material disappeared. The poly(vinyl alcohol) solutions were clear, transparent solutions.

TABLE 3

| | | 4 weight % Aqueous | |
|---|---|---|---|
| | | Viscosity | Solids Level |
| PVOH | Hydrolysis Level (%) | at 20° C. (cp) | (weight %) |
| PVOH-1 | 99+ | 27-33 | 11.5 |
| PVOH-2 | 95-97 | 25-30 | 10.6 |
| PVOH-3 | 90-93 | 27-33 | 11.2 |
| PVOH-4 | 87-89 | 5-6 | 12.6 |
| PVOH-5 | 87-89 | 44-50 | 12 |
| PVOH-6 | 87-89 | 23-27 | 10 |
| PVOH-7 | 87-89 | 11-14 | 10 |

Blends of the aqueous ionomer dispersion with the aqueous poly(vinyl alcohol) solutions were prepared by mixing them together at room temperature to prepare the blend compositions summarized in Table 4. Specifically, each of the aqueous poly(vinyl alcohol) solutions were mixed with the aqueous ionomer dispersion in ratios of 80:20; 60:40; 40:60 and 20:80 (weight:weight).

The viscosities of the Examples and Comparative Examples were measured using a TA Instruments AR 2000 controlled-stress rheometer equipped with narrow-gap (1 mm) concentric cylinder geometry. The concentric cylinder geometry consists of a temperature controlled jacket, a cup (or stator), and a DIN rotor (or bob). When a test was performed, the sample was placed in the cup and then the rotor was inserted. Since the drag of the fluid on the rotor is proportional to the surface area, the contribution to the measured torque from the shaft of the rotor was small relative to the fat part of the rotor. As a result, the height of the fluid on the shaft was not critical and the cup was filled so that the height of the fluid in the cup was above the thick part of the rotor when the rotor was inserted. A solvent cover was placed over the top of the cup. This helped to minimize the effects of solvent evaporation or moisture absorption on the measured properties.

Instrument bias was checked using a nominal 10 cP (actual viscosity 9.5 cP) and a nominal 10,000 cP (actual viscosity 9860 cP) viscosity standard. The bias was 4% or less for both standards at shear rates from 0.1 to 100 sec⁻¹.

The viscosity of the test samples was measured at 25° C. The concentric cylinder geometry was set at the desired test temperature. Proportional amounts of each material for a total of 20 mL were loaded into the cup using a syringe, the solutions were mixed using a spatula for 10 seconds, the DIN was lowered to a gap of 5920 μm between the bottom of the rotor and the cup, a cover was placed over the geometry, and the test was started. A time sweep was performed at a shear rate of 20 sec⁻¹. The viscosity for each sample was monitored as a function of time by taking data points every 10 seconds up to 1800 seconds. The measurement was performed at least in duplicate with a fresh sample loading each time and the average values are reported in Tables 4 and 5 at representative time points. The column entry “Viscosity Ratio” denotes the ratio of the viscosity of the ionomer-PVOH blend dispersion to the viscosity of the PVOH dispersion without ionomer, each measured at 1800 seconds. Table 5 summarizes a similar comparison using a 10 weight % aqueous solution of PVOH-7 blended with a 10 weight % aqueous dispersion of ION-8. Viscosity measurements on ION-8 reported in Table 5 were run at 100 rpm and 25° C. using a #1 spindle and the PVOH and blends at 60 rpm and 25° C. using a #2 spindle.

TABLE 4

| | Composition | Viscosity (cp) after time (seconds) | | | | | | Viscosity |
|---|---|---|---|---|---|---|---|---|
| Example | (weight % in water) | 10 | 100 | 500 | 1000 | 1500 | 1800 | Ratio |
| C1 | ION-8 (11.6) | 3 | 3 | 2 | 2 | 2 | 2 | — |
| C2 | PVOH-1 (11.5) | 792 | 773 | 767 | 767 | 766 | 766 | — |
| C3 | PVOH-1 (9.2) | 368 | 373 | 399 | 423 | 448 | 463 | 0.6 |
| | ION-8 (2.3) | | | | | | | |
| C4 | PVOH-1 (6.9) | 152 | 156 | 172 | 187 | 201 | 211 | 0.28 |
| | ION-8 (4.6) | | | | | | | |
| C5 | PVOH-1 (4.6) | 51 | 52 | 58 | 63 | 67 | 70 | 0.09 |
| | ION-8 (7.0) | | | | | | | |
| C6 | PVOH-1 (2.3) | 15 | 15 | 16 | 17 | 18 | 19 | 0.03 |
| | ION-8 (9.3) | | | | | | | |
| C7 | PVOH-2 (10.6) | 484 | 478 | 476 | 476 | 476 | 476 | — |
| C8 | PVOH-2 (8.5) | 415 | 423 | 455 | 492 | 534 | 562 | 1.18 |
| | ION-8 (2.3) | | | | | | | |
| C9 | PVOH-2 (6.4) | 328 | 338 | 386 | 440 | 510 | 560 | 1.17 |
| | ION-8 (4.6) | | | | | | | |
| C10 | PVOH-2 (4.2) | 247 | 260 | 319 | 382 | 455 | 510 | 1.07 |
| | ION-8 (7.0) | | | | | | | |
| C11 | PVOH-2 (2.1) | 118 | 124 | 156 | 185 | 215 | 236 | 0.49 |
| | ION-8 (9.3) | | | | | | | |
| C12 | PVOH-3 (11.2) | 740 | 733 | 730 | 731 | 731 | 731 | — |
| 1 | PVOH-3 (9.0) | 741 | 754 | 815 | 890 | 970 | 1030 | 1.41 |
| | ION-8 (2.3) | | | | | | | |
| 2 | PVOH-3 (6.7) | 847 | 887 | 1065 | 1267 | 1526 | 1724 | 2.36 |
| | ION-8 (4.6) | | | | | | | |
| 3 | PVOH-3 (4.5) | 1030 | 1120 | 1530 | 1970 | 2520 | 2960 | 4.05 |
| | ION-8 (7.0) | | | | | | | |
| 4 | PVOH-3 (2.2) | 980 | 1090 | 1440 | 1860 | 2500 | 3000 | 4.1 |
| | ION-8 (9.3) | | | | | | | |
| C13 | PVOH-4 (12.6) | 32 | 31 | 31 | 31 | 31 | 31 | — |
| C14 | PVOH-4 (10.1) | 28 | 27 | 27 | 28 | 28 | 28 | 0.91 |
| | ION-8 (2.3) | | | | | | | |
| C15 | PVOH-4 (7.6) | 27 | 27 | 28 | 29 | 29 | 30 | 0.96 |
| | ION-8 (4.6) | | | | | | | |
| C16 | PVOH-4 (5.0) | 30 | 30 | 31 | 33 | 35 | 37 | 1.19 |
| | ION-8 (7.0) | | | | | | | |
| C17 | PVOH-4 (2.5) | 23 | 22 | 23 | 25 | 26 | 27 | 0.87 |
| | ION-8 (9.3) | | | | | | | |
| C18 | PVOH-5 (12) | 1716 | 1701 | 1694 | 1694 | 1695 | 1696 | — |
| 5 | PVOH-5 (9.6) | 1760 | 1800 | 1903 | 2045 | 2209 | 2322 | 1.37 |
| | ION-8 (2.3) | | | | | | | |
| 6 | PVOH-5 (7.2) | 2370 | 2760 | 3320 | 4010 | 4800 | 5400 | 3.18 |
| | ION-8 (4.6) | | | | | | | |
| 7 | PVOH-5 (4.8) | 3700 | 6600 | 8800 | 10700 | 13000 | 14600 | 8.61 |
| | ION-8 (7.0) | | | | | | | |
| 8 | PVOH-5 (2.4) | 12800 | 14800 | 17100 | 19900 | 22400 | 23400 | 13.8 |
| | ION-8 (9.3) | | | | | | | |
| C19 | PVOH-6 (10) | 583 | 583 | 583 | 583 | 583 | 583 | — |
| 9 | PVOH-6 (8) | 709 | 714 | 744 | 791 | 841 | 877 | 1.50 |
| | ION-8 (2) | | | | | | | |
| 10 | PVOH-6 (6) | 1270 | 1400 | 1580 | 1810 | 2090 | 2280 | 3.91 |
| | ION-8 (4) | | | | | | | |
| 11 | PVOH-6 (4) | 2590 | 3310 | 4360 | 5120 | 5960 | 6490 | 11.13 |
| | ION-8 (6) | | | | | | | |
| 12 | PVOH-6 (2) | 6050 | 8200 | 9370 | 1040 | 11370 | 11970 | 20.53 |
| | ION-8 (8) | | | | | | | |

TABLE 5

| | Composition | Viscosity (cp) after time (seconds) | | | | | | | Viscosity |
|---|---|---|---|---|---|---|---|---|---|
| Example | (weight % in water) | 0 | 300 | 600 | 900 | 1200 | 1500 | 1800 | Ratio |
| C5 | ION-8 (10) | na | na | na | na | na | na | 5.2 | — |
| C6 | PVOH-5 (10) | na | na | na | na | na | na | 236 | — |
| 13 | PVOH-5 (6) | 229 | 209 | 211 | 229 | 214 | 205 | 206 | 0.87 |
| | ION-8 (4) | | | | | | | | |

The data in Table 4 show that the viscosity of the ionomer dispersion (Comparative Example C1) declined slightly and then stabilized at about 2 cp over the course of measurement until 1800 seconds when the measurement was stopped. The viscosity of each of the poly(vinyl alcohol) dispersions (Comparative Examples C2, C7, C12, C13, C18 and C19) showed similar behavior, stabilizing at various levels ranging from 31 cp (C13) to 1696 cp (C18).

When aqueous suspensions of fully hydrolyzed PVOH-1 with the ionomer ION-8 were prepared (Comparative Examples C3-C6), the viscosity declined compared to the viscosity of Comparative Example C2 and decreased as the ratio of ionomer to PVOH increased.

When aqueous suspensions of highly hydrolyzed PVOH-2 with the ionomer ION-8 were prepared (Comparative Examples C8-C11), the viscosity compared to the viscosity of Comparative Example C7 increased somewhat with low amounts of ionomer and then decreased as the ratio of ionomer to PVOH increased.

There was little effect on the viscosity of aqueous dispersions comprising PVOH-4 and ION-8 (Comparative Examples C14-C17) compared to the viscosity of Comparative Example C13.

The viscosity behavior for the 60:40 blend of PVOH-7 and ION-8 (Table 5) was similar to the behavior of the other Comparative Examples.

However, when PVOH-3, PVOH-5 and PVOH-6 were combined with ION-8, the viscosity of Examples 1 to 12 exhibited surprising behavior compared to the solutions of PVOH-3, PVOH-5 and PVOH-6 without ionomer (Comparative Examples C12, C18 and C19, respectively). Those dispersions demonstrated a dramatic increase in viscosity with the combination of ionomer and PVOH, with increases in viscosity of greater than 25% at a 1:4 ratio of ionomer to PVOH. The viscosity further increased as the proportion of ionomer increased, with increases of about 4 to about 20 times that of the respective PVOH solution without ionomer when the ionomer was present in a 4:1 ratio to the PVOH.

The following Comparative Examples show that successful preparation of the ionomer-PVOH blend dispersion depends on preparing a solution of PVOH prior to combination with the ionomer.

### Comparative Example C20

Eighteen grams of ION-8, in the form of melt cut pellets, was stirred in 180 grams of water at a temperature of 23° C. Two grams of PVOH-3 was added with stirring and the resulting mixture was heated to a temperature of 90 to 95° C. Even after hours of stirring at this temperature, a significant amount of the ION-8 remained undispersed in the water in the form of the original melt cut pellets.

### Comparative Example C21

Sixteen grams of ION-8, in the form of melt cut pellets, was stirred in 180 grams of water at a temperature of 93° C. ION-8 completely formed a dispersion after 15 minutes, with the water temperature rising to about 99° C. Four grams of PVOH-6 was added with stirring. Upon contact with the hot water, the poly(vinyl alcohol) formed a single lump due to the particles sticking to each other. The resulting mixture was heated to a temperature of 99° C. for 15 minutes with no significant change in the poly(vinyl alcohol) lump size. At that time, it appeared that the poly(vinyl alcohol) had not dissolved.

### Comparative Example C22

Eighteen grams of ION-8, in the form of melt cut pellets, was stirred in 180 grams of water at a temperature of 23° C. The pH of the stirred mixture was adjusted to a pH of 9.8 by the addition of a 5 weight % aqueous sodium hydroxide solution. 2 grams of PVOH-6 was added with stirring and the resulting mixture was heated to a temperature of 93° C. over 26 minutes. At this time, it appeared that the PVOH-4 had dissolved, but that the ION-8 remained as the original melt cut pellets and had not dispersed within the hot water. After stirring at a temperature of 93-100° C. for an additional hour, a significant amount of the ION-8 remained undispersed in the water in the form of the original melt cut pellets.

### Example 13

This example represents the embodiment wherein a solid ionomer composition is contacted with an aqueous PVOH solution. Two grams of PVOH-6 was stirred in 180 grams of water at a temperature of 23° C. The resulting mixture was heated to a temperature of 39° C. over 13 minutes to form a clear, aqueous solution. Heating was continued until the solution reached a temperature of 96° C. in 15 minutes and 9 grams of ION-8, in the form of melt cut pellets, was added with stirring. Within 2 minutes, the ION-8 had completely dispersed within the water and an additional 9 grams of ION-8, in the form of melt cut pellets, was added. Within 17 minutes, all of the added ION-8 had completely dispersed into the water and heating was discontinued.

What is claimed is:

1. A blend composition comprising
(a) about 99 to about 1 weight %, based on the combination of (a) and (b), of a poly(vinyl alcohol) composition comprising or consisting essentially of a poly(vinyl alcohol) with a hydrolysis level of from about 85 to about 93 mol % and a 4 weight aqueous viscosity at 20° C. of from 16 to about 75 centipoise (cp); and
(b) about 1 to about 99 weight %, based on the combination of (a) and (b), of an ionomer composition comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof.

2. The blend composition of claim 1 comprising an ionomer wherein the cations of the carboxylate salts consist essentially of sodium cations.

3. The blend composition of claim 1 comprising an ionomer wherein the cations of the carboxylate salts consist essentially of potassium cations.

4. The blend composition of claim 1 wherein (b) is present in the combination of (a) and (b) in an amount from about 10 to about 95 weight %, (a) being present in a complementary amount.

5. The blend composition of claim 1 wherein (b) is present in the combination of (a) and (b) in an amount from about 60 to about 95 weight %, (a) being present in a complementary amount.

6. The blend composition of claim 1 wherein the poly(vinyl alcohol) is characterized by a 4 weight % aqueous viscosity at 20° C. of about 20 to about 75 cp.

7. The blend composition of claim 6 wherein the poly(vinyl alcohol) is characterized by a 4 weight % aqueous viscosity at 20° C. of about 20 to about 50 cp.

8. The blend composition of claim 1 wherein the acid copolymer has a MFR from about 250 to about 400 g/10 min.

9. The composition of claim 1 in the form of an aqueous dispersion comprising water and about 0.001 to about 50 weight % of the combination of (a) and (b).

10. The aqueous dispersion of claim 9 comprising an ionomer wherein the cations of the carboxylate salts consist essentially of sodium cations.

11. The aqueous dispersion of claim 9 comprising an ionomer wherein the cations of the carboxylate salts consist essentially of potassium cations.

12. The aqueous dispersion of claim 9 wherein (b) is present in the combination of (a) and (b) in an amount from about 10 to about 95 weight %, (a) being present in a complementary amount.

13. The aqueous dispersion of claim 9 wherein (b) is present in the combination of (a) and (b) in an amount from about 60 to about 95 weight %, (a) being present in a complementary amount.

14. The aqueous dispersion of claim 9 wherein the poly(vinyl alcohol) is characterized by a 4 weight % aqueous viscosity at 20° C. of about 20 to about 75 cp.

15. The aqueous dispersion of claim 14 wherein the poly(vinyl alcohol) is characterized by a 4 weight % aqueous viscosity at 20° C. of about 20 to about 50 cp.

16. The aqueous dispersion of claim 9 wherein the acid copolymer has a MFR from about 250 to about 400 g/10 min.

17. The aqueous dispersion of claim 9 comprising from about 0.001 to about 50 weight % of the combination of (a) and (b), based on the total weight of the combination of (a) and (b) and water.

18. A method to produce an aqueous dispersion of claim 9 comprising
(1) providing an aqueous poly(vinyl alcohol) solution comprising water and a poly(vinyl alcohol) composition comprising a poly(vinyl alcohol) wherein the poly(vinyl alcohol) is characterized by a hydrolysis level of from about 85 to about 93 mol % and a 4 weight % aqueous viscosity at 20° C. of from 16 to about 75 cp;
(2) providing an ionomer composition comprising an ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof;
(3) mixing the ionomer composition with the aqueous poly(vinyl alcohol) composition solution optionally with heating to provide a heated aqueous blend dispersion; and
(4) optionally cooling the heated aqueous blend dispersion to a temperature of about 20 to 30° C., wherein the combination remains dispersed in the liquid phase.

19. The method of claim 18 wherein the aqueous poly(vinyl alcohol) solution comprises from about 0.001 to about 50 weight % of the poly(vinyl alcohol), based on the total weight of the poly(vinyl alcohol) and water.

20. The method of claim 18 wherein the poly(vinyl alcohol) is characterized by a 4 weight % aqueous viscosity at 20° C. of about 20 to about 75 cp.

21. The method of claim 19 wherein the poly(vinyl alcohol) is characterized by a 4 weight % aqueous viscosity at 20° C. of about 20 to about 50 cp.

22. The method of claim 18 wherein the ionomer composition is an aqueous dispersion comprising the ionomer and water.

23. The method of claim 22 wherein the aqueous dispersion is produced by contacting a solid ionomer composition with water at a temperature from about 80 to about 100° C.; optionally followed by cooling to a temperature of about 20 to about 30° C., wherein the ionomer remains dispersed in the aqueous phase; and wherein the aqueous dispersion comprises from about 0.001 to about 50 weight % of the ionomer, based on the total weight of the ionomer and water.

24. The method of claim 18 wherein the ionomer composition is in solid form and the mixing comprises
(a) heating the aqueous poly(vinyl alcohol) solution to a temperature from about 80 to about 100° C.;
(b) contacting the solid ionomer composition with the heated aqueous poly(vinyl alcohol) solution;
(c) continuing heating at a temperature from about 80 to about 100° C. until the solid ionomer composition has completely dispersed.

25. The method of claim 18 wherein the ionomer composition is in solid form and the mixing comprises
(b) contacting the solid ionomer composition with the aqueous poly(vinyl alcohol) solution to provide a mixture;
(c) heating the mixture to a temperature from about 80 to about 100° C. until the solid ionomer composition has completely dispersed.

26. An article comprising the blend composition of claim 1.
